(19) United States
(12) Patent Application Publication
(10) Pub. No.: US 2004/0084398 A1
(43) Pub. Date: May 6, 2004

(54) Module, especially a wafer module

(76) Inventors: Klaus Breitschwerdt, Filderstadt (DE); Hans Artmann, Magstadt (DE); Wilhelm Frey, Mountain View, CA (US); Karsten Funk, Mountain View, CA (US); Juergen Neumann, Reitenbuch (DE)

Correspondence Address: KENYON & KENYON, ONE BROADWAY, NEW YORK, NY, 10004, US

(21) Appl. No.: 10/343,820

(22) PCT Filed: Jul. 20, 2001
(86) PCT No.: PCT/DE01/02758

(30) Foreign Application Priority Data
Aug. 3, 2000 (DE) 100 37 821.8

(51) Int. Cl. H01B 13/00

(52) U.S. Cl. 216/13

(57) ABSTRACT

The module (10) described is in particular a wafer module, and has two oppositely situated functional elements (11, 12) which are functionally interconnected by a compression-deformable joining agent layer (13) located in between. At least one functional element (11; 12; 11, 12) is surface-structured to form a recess (14), and the functional connection is present exclusively in the region of the recess (14).

The present invention relates to a module, in particular a wafer module, having two oppositely situated functional elements which are functionally interconnected by a compression-deformable layer of a joining agent located in between, according to the preamble of claim 1.

### BACKGROUND INFORMATION

The creation of a functional connection between wafers made of silicon, using an adhesive as a joining agent which for example is paste-like and therefore compression-deformable and which is located between the wafers, is known. Modules having such a design are used in particular in the fields of electronics or microsystems engineering. Also known is a sealing glass which is frequently used in Microsystems engineering as a joining agent to produce wafer connections. Compared to other adhesive materials, sealing glass has the advantage that it is suited for creating a vacuum-tight connection between functional elements, in particular in the form of silicon wafers. In the screen printing process, the sealing glass is applied as a compression-deformable paste to a joining surface of at least one functional element (wafer). The two functional elements are then pressed together at their joining surfaces against the melted sealing glass layer located in between, at an operating temperature of approximately 430° C. A functional connection is created between the two functional elements due to the surface forces which arise between each joining surface and the sealing glass, forming a wafer module. The quality of a functional connection obtained in this manner depends in particular on the operating parameters of sealing glass temperature and pressure force on the two functional elements (wafers) to be connected.

The essentially known sealing glass is provided with numerous filler particles of various sizes. It is disadvantageous that the minimum gap height that can be set between the functionally interconnected functional elements depends on the maximum size of the filler particles contained in the sealing glass. For example, thus far it has been possible to set minimum gap heights in a range of approximately 10 μm±5 μm between two oppositely situated and functionally connected functional elements of a wafer module by using sealing glass as the joining agent. For certain applications in Microsystems engineering, this gap height is too large, or its adjustment tolerance is too imprecise.

### ADVANTAGES OF THE INVENTION

The module of the aforementioned type according to the present invention is characterized by the fact that at least one functional element is surface-structured to form a recess, and the functional connection is present exclusively in the region of the recess. Two functional elements may thus be functionally connected using a compression-deformable layer of a joining agent in between, it being possible to bring the flat, for example, joining surfaces of the functional elements outside the region of the recess together in mutual contact (gap height equal to zero). Since the compression-deformable joining agent, for example sealing glass, is situated in the region of a recess in the surface structuring of at least one functional element, and the functional connection between the two functional elements is achieved in this region only, a functional connection that is reproducible and independent of the physical and material properties, i.e., characteristics of the joining agent may be created for manufacturing a module. The geometric configuration of the module is therefore not limited by a minimum settable gap height between the functionally connected functional elements in a region outside the recess. The surface structuring may thus be produced on the joining surface of a functional element in a known manner by using a wet- or dry-chemical structuring method, such as the plasma trench method, for example, to form a recess (cavern). The joining agent, for example sealing glass, may also be applied to the joining surface of a functional element in the region of the recess created, using a known method (screen printing process). Thus, the functional connection which is formed in the region of the recess between the oppositely situated functional elements is a type of friction fit connection. Advantageously, any given gap height between the functionally connected functional elements may be set to be equal to or greater than zero by using such a friction fit connection.

It is advantageous if, before the layer of the joining agent applied to a functional element in the region of the recess is compression-deformed by bringing the two functional elements together, the layer has a height that is greater than the sum of the depth of the recess and a remaining minimum distance to be set between the functional elements and a region outside the recess. This ensures that the joining agent in the region of the recess enters into functional connection with both functional elements to be brought together, thus guaranteeing a reliable functional connection between the functional elements.

The minimum remaining volume for receiving the joining agent in the functional elements is advantageously equal to or greater than the material volume of the layer of the joining agent which is not compression-deformed. This ensures that the joining agent, during its compression deformation when the two oppositely situated functional elements are brought together, is able to extend or spread, in particular laterally, unhindered in the correspondingly reduced volume for receiving the joining agent until the minimum remaining receiving volume for the joining agent is set when the functional elements are brought together to maximum proximity. The two functional elements may thus be brought together unimpeded, while at the same time the compression-deforming joining agent adapts to the geometry of the correspondingly decreasing volume for receiving the joining agent in the region of the recess. The two functional elements are brought together to maximum proximity by creating a direct contact bond between the joining surfaces of the functional elements outside the region of the recess.

According to a first embodiment of the present invention, the minimum volume for receiving the joining agent is the volume of the recess. In this case a functional element which is not surface-structured, for example, having a flat joining surface may easily be brought against the oppositely situated, surface-structured functional element until direct surface contact is made between the two joining surfaces (gap height equal to zero) outside the region of the recess.

According to an additional, alternative embodiment, each of the functional elements has an oppositely situated recess, the minimum volume for receiving the joining agent being the sum of the individual volumes of the recesses. Also in this embodiment having two surface-structured functional elements, it is possible to bring the functional elements together in an unhindered manner to create a direct contact bond between the joining surfaces outside the region of the recesses. All desired gap heights between the functional elements of the module may thus be set relatively easily and reliably.

It is advantageous if, before the layer of the joining agent applied to a functional element is compression-deformed, the height of the layer is greater than the sum of the depths of the oppositely situated recesses and a remaining minimum distance to be set between the functional elements in a region outside the recesses. In the embodiment having two surface-structured functional elements, it is thus ensured that a reliable functional connection is created between the joining agent and the particular functional element inside the corresponding recess after the two functional elements are brought together until the desired remaining minimum distance is achieved.

The recess preferably has a rectangular, circular, or V-shaped cross section. The recess may be produced using a plasma trench method, for example, on the joining surface of a functional element, a recess having for example a rectangular cross section being manufacturable using a relatively easy and precise manufacturing technique.

Advantageously, the layer of the joining agent is a sealing glass layer, and the functional elements are manufactured from silicon. As a joining agent, sealing glass is particularly suited for producing a vacuum-tight functional connection, for example between two silicon wafers, to form a wafer module. However, it is also possible to use other suitable joining materials, such as adhesive or soldering materials. The functional elements may also be made from other suitable materials.

Additional advantageous embodiments of the present invention arise from the description.

### DRAWINGS

The present invention is described in greater detail below in several exemplary embodiments, with reference to an associated drawing.

FIG. 1 shows a schematic illustration of a module according to the present invention which is not completely functionally connected, according to a first embodiment;

FIG. 2 shows a schematic illustration of the completely functionally connected module of FIG. 1;

FIG. 3 shows a schematic illustration of a module according to the present invention which is not completely functionally connected, according to a second, alternative embodiment;

FIG. 4 shows a schematic illustration of the completely functionally connected module of FIG. 3;

FIG. 5 shows a schematic illustration of a module according to the present invention which is not completely functionally connected, according to a third, alternative embodiment;

FIG. 6 shows a schematic illustration of the completely functionally connected module of FIG. 5; and

FIG. 7 shows a schematic cross-sectional illustration of a functional element according to the present invention having an applied joining agent, in enlarged scale compared to FIGS. 1 through 6.

### DESCRIPTION OF THE INVENTION

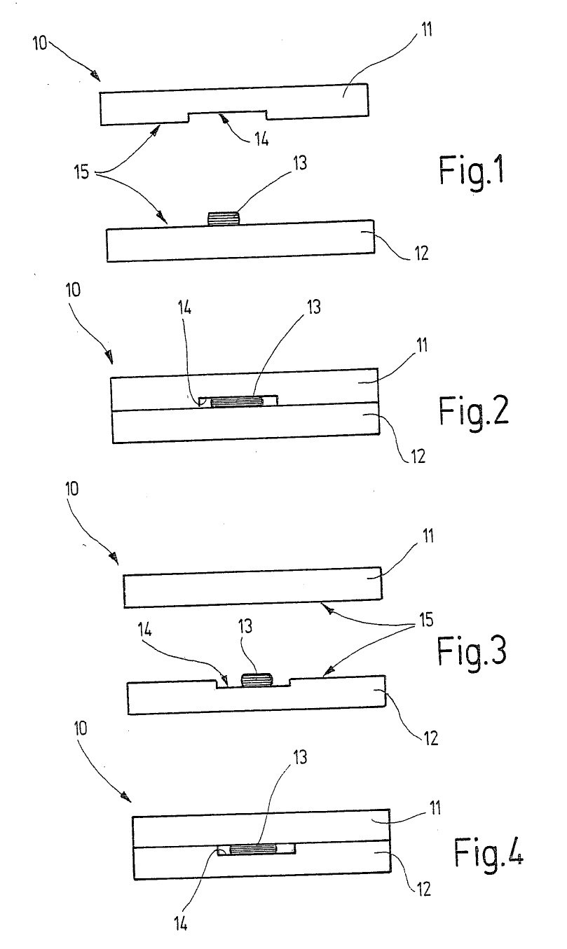

FIGS. 1 and 2 show a module 10, for example a wafer module, having two oppositely situated functional elements 11, 12 which are to be functionally interconnected (FIG. 1) or which are functionally interconnected (FIG. 2) by a compression-deformable joining agent layer 13 located in between. Functional elements 11, 12 may be silicon wafers, for example, while a sealing glass, for example, is used as a joining agent for producing a vacuum-tight functional connection between two functional elements 11, 12. Functional element 11 has an essentially flat joining surface 15 which is surface-structured to form a recess 14. Recess 14 has a substantially rectangular cross section. Functional element 12 has a completely flat, non-surface-structured joining surface 15 upon which joining agent layer 13 is applied inside the region of oppositely situated recess 14 in functional element 11. As illustrated in FIG. 2, the functional connection between two functional elements 11, 12 is achieved exclusively in the region of recess 14 in functional element 11. Joining surface 15 of functional element 11, which extends outside the region of recess 14, has a flat design and may easily be brought into contact with corresponding joining surface 15 of functional element 12, with corresponding compression deformation of joining agent layer 13. Thus, it is advantageously possible to easily set any given gap height in a module 10 between joining surfaces 15 outside the region of recess 14.

FIGS. 3 and 4 show a second, alternative embodiment of module 10 according to the present invention, joining agent layer 13 being applied inside a recess 14 to a joining surface 15 according to FIG. 3 before a complete functional connection is created between two functional elements 11, 12 according to FIG. 4. In contrast, in the first embodiment according to FIG. 1, joining agent layer 13 has been applied to non-structured joining surface 15 before a complete functional connection is produced between functional elements 11, 12. The subsequent geometric structure of the second, alternative embodiment according to FIGS. 3 and 4 corresponds to that of the first embodiment according to FIGS. 1 and 2.

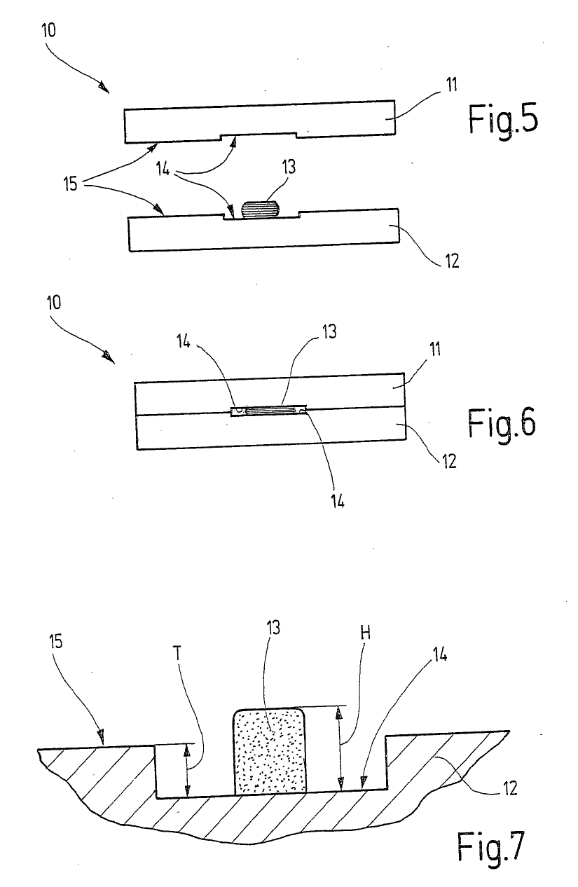

FIGS. 5 and 6 show a third, alternative embodiment having two functional elements 11, 12, the joining surfaces 15 of which are each surface-structured to form a corresponding recess 14. In FIG. 5, joining agent layer 13 is applied to a joining surface 15 in the region of oppositely facing recesses 14 before a complete functional connection is produced between functional elements 11, 12. FIG. 6 shows that the functional connection between functional elements 11, 12 created by joining agent layer 13 is achieved exclusively in the region of the two recesses 14.

All modules 10 according to FIGS. 2, 4, and 6 are characterized by the fact that it is possible to set a gap height between joining surfaces 15 outside the region of recesses 14 which is freely selectable and independent of characteristics of the joining agent (for example, the particle size of the sealing glass filler). Because of the geometric structuring of the joining surface of at least one functional element, a type of friction-fit functional connection is produced between functional elements 11, 12 by using joining agent layer 13 as the construction element.

To ensure a reliable functional connection between joining agent layer 13 and joining surfaces 15 in the region of recesses 14, before applied joining agent layer 13 is compression-deformed by bringing two functional elements 11, 12 together the layer must have a height H which is greater than the sum of depth T of recess 14 of functional element 12 or 11 (embodiment according to FIG. 3 or FIG. 1, respectively) and, if needed, of depth T of additional recess 14 in functional element 11 or 12 (embodiment according to FIG. 5) and, if needed, of a remaining minimum distance to be set between functional elements 11, 12 in a region outside recess or recesses 14 (also see FIG. 7).

As illustrated in FIGS. 2, 4, and 6, the minimum volume of functional elements 11, 12 for receiving the joining agent is greater than the material volume of the layer of joining agent (see FIGS. 1, 3, and 5) which is not compression-deformed. In addition, FIGS. 2, 4, and 6 show that the cross-sectional area of the minimum volume of functional elements 11, 12 for receiving the joining agent is not completely filled with joining agent after a complete, proper functional connection between the functional elements is achieved. This allows a gap (not shown) between functional elements 11, 12 outside the region of recess 14 to be easily and freely selectably set after the remaining functional connection between the functional elements is achieved.

What is claimed is:

1. A module, in particular a wafer module, comprising two oppositely situated functional elements which are functionally interconnected by a compression-deformable layer of a joining agent located in between,
wherein at least one functional element (11; 12; 11, 12) is surface-structured to form a recess (14), and the functional connection is present exclusively in the region of the recess (14).

2. The module as recited in claim 1,
wherein, before the joining agent layer (13) applied to a functional element (12) in the region of the recess (14) is compression-deformed by bringing the two functional elements (11, 12) together, the layer has a height (H) that is greater than the sum of the depth (T) of the recess (14) and a remaining minimum distance to be set between the functional elements (11, 12) and a region outside the recess (14).

3. The module as recited in one of the preceding claims,
wherein the minimum volume of the functional elements (11, 12) for receiving the joining agent is equal to or greater than the material volume of the joining agent layer (13) which is not compression-deformed.

4. The module as recited in one of the preceding claims,
wherein the minimum volume for receiving the joining agent is the volume of the recess (14).

5. The module as recited in one of the preceding claims,
wherein each of the functional elements (11, 12) has an oppositely situated recess (14), and the minimum volume for receiving the joining agent is the sum of the individual volumes of the recesses (14).

6. The module as recited in one of the preceding claims,
wherein, before the joining agent layer (13) applied to a functional element (11, 12) is compression-deformed, the height (H) of the layer is greater than the sum of the particular depth (T) of the oppositely situated recesses (14) and a remaining minimum distance to be set between the functional elements (11, 12) in a region outside the recesses (14).

7. The module as recited in one of the preceding claims,
wherein the recess (14) has a rectangular, circular, or V-shaped cross section.

8. The module as recited in one of the preceding claims,
wherein the joining agent layer (13) is a sealing glass layer, and the functional elements (11, 12) are manufactured from silicon.
